(19) United States
(12) Patent Application Publication
(10) Pub. No.: US 2026/0303948 A1
(43) Pub. Date: Oct. 1, 2026

(54) IMAGING APPARATUS, CONTROL METHOD, AND INTERCHANGEABLE LENS

(71) Applicant: Panasonic Intellectual Property Management Co., Ltd., Osaka (JP)

(72) Inventors: Naotaka KISHIDA, Osaka (JP); Takahiro IKEDA, Osaka (JP); Katsuya NAKANISHI, Osaka (JP); Takaaki YAMASAKI, Osaka (JP); Ryo KOTAKI, Osaka (JP)

(73) Assignee: Panasonic Intellectual Property Management Co., Ltd., Osaka (JP)

(21) Appl. No.: 19/574,276

(22) Filed: Mar. 21, 2026

(30) Foreign Application Priority Data
Mar. 26, 2025 (JP) 2025-051567

(51) Int. Cl. H04N 23/62; H04N 23/55; H04N 23/667

(52) U.S. Cl. CPC H04N 23/62; H04N 23/55; H04N 23/667

(57) ABSTRACT

An imaging apparatus includes: an image sensor that captures a subject image via an optical system to generate image data; and a controller that controls an operation of the optical system. The optical system is provided with: a first operation member that changes a first operation parameter; and a second operation member that changes a second operation parameter. The controller: detects a first operation direction that associates a user operation on the first operation member with a change in the first operation parameter; and sets a second operation direction in the second operation member to change the second operation direction in accordance with the detected first operation direction, the second operation direction associating a user operation on the second operation member with a change in the second operation parameter.

### TECHNICAL FIELD

The present disclosure relates to an imaging apparatus, a control method, and an interchangeable lens that use an operation member provided in an optical system.

### BACKGROUND ART

JP 2008-42847 A discloses an image processing apparatus such as a digital camera relating to an electronic zoom technique for electronically changing the angle of view of a captured image. The image processing apparatus shifts from the first electronic zoom processing to the second electronic zoom processing when a user performs a predetermined operation by the zoom operation means, and restricts the shift from the first electronic zoom processing to the second electronic zoom processing when the user does not perform the operation. The image processing apparatus of JP 2008-42847 A is intended to improve the usability of the electronic zoom.

### SUMMARY

The present disclosure provides an imaging apparatus, a control method, and an interchangeable lens that can facilitate operation using an operation member provided in an optical system.

In the present disclosure, an imaging apparatus includes: an image sensor that captures a subject image via an optical system to generate image data; and a controller that controls an operation of the optical system. The optical system is provided with: a first operation member that changes a first operation parameter; and a second operation member that changes a second operation parameter. The controller: detects a first operation direction that associates a user operation on the first operation member with a change in the first operation parameter; and sets a second operation direction in the second operation member to change the second operation direction in accordance with the detected first operation direction, the second operation direction associating a user operation on the second operation member with a change in the second operation parameter.

The present disclosure provides a control method for controlling an operation by an optical system of an imaging apparatus. The optical system being provided with: a first operation member that changes a first operation parameter; and a second operation member that changes a second operation parameter. The control method includes: detecting, by a controller of the imaging apparatus, a first operation direction that associates a user operation on the first operation member with a change in the first operation parameter; and setting, by the controller, a second operation direction in the second operation member to change the second operation direction in accordance with the detected first operation direction, the second operation direction associating a user operation on the second operation member with a change in the second operation parameter.

In the present disclosure, an interchangeable lens detachably attachable to an imaging apparatus, including: a communication interface that communicates data with the attached imaging apparatus; an optical system that forms an image on an image sensor of the imaging apparatus, based on incident light; a first operation member that changes a first operation parameter; a second operation member that changes a second operation parameter; and a controller that controls an operation of the optical system, based on information received from the imaging apparatus via the communication interface. The controller: causes the imaging apparatus to detect a first operation direction by data communication with the imaging apparatus via the communication interface, the first operation direction associating a user operation on the first operation member with a change in the first operation parameter; receives setting information from the imaging apparatus via the communication interface, the setting information indicating a second operation direction that associates a user operation on the second operation member with a change in the second operation parameter; and in response to a user operation on the second operation member, causes the optical system to change the second operation parameter in accordance with the second operation direction indicated by the setting information.

According to the imaging apparatus, the control method, and the interchangeable lens of the present disclosure, it is possible to facilitate an operation using an operation member provided in an optical system.

### BRIEF DESCRIPTION OF THE DRAWINGS

FIG. 1 is a block diagram showing a configuration of a digital camera according to a first embodiment of the present disclosure;

FIG. 2 is a rear view of the camera body in the digital camera;

FIG. 3 is a diagram illustrating a configuration of a focus ring in an interchangeable lens of the digital camera;

FIG. 4 is a timing chart illustrating a detection signal of the focus ring in the interchangeable lens;

FIGS. 5A and 5B are diagrams for explaining an outline of the operation of the digital camera according to the first embodiment;

FIG. 6 is a flowchart illustrating an example of MF setting process in the digital camera of the first embodiment;

FIG. 7 is a diagram showing a display example of a setting menu in the digital camera according to the first embodiment;

FIG. 8 is a flowchart illustrating an operation of the interchangeable lens in the digital camera of the first embodiment;

FIG. 9 is a flowchart illustrating the operation of the interchangeable lens following FIG. 8;

FIGS. 10A to 10C are diagrams showing a display example of a setting menu in the digital camera according to a second embodiment;

FIGS. 11A and 11B are diagrams showing a display example of a ring rotation direction selection screen in the digital camera of the second embodiment; and

FIG. 12 is a flowchart illustrating an example of electronic zoom setting process in the digital camera of the second embodiment.

### DETAILED DESCRIPTION

Hereinafter, embodiments will be described in detail with reference to the drawings as appropriate. However, unnecessarily detailed description may be omitted. The accompanying drawings and the following description are provided for those skilled in the art to fully understand the present disclosure, and are not intended to limit the subject matter described in the appended claims.

### First Embodiment

Hereinafter, a configuration and an operation of an embodiment of an imaging apparatus according to the present disclosure will be described.

### 1. Configuration

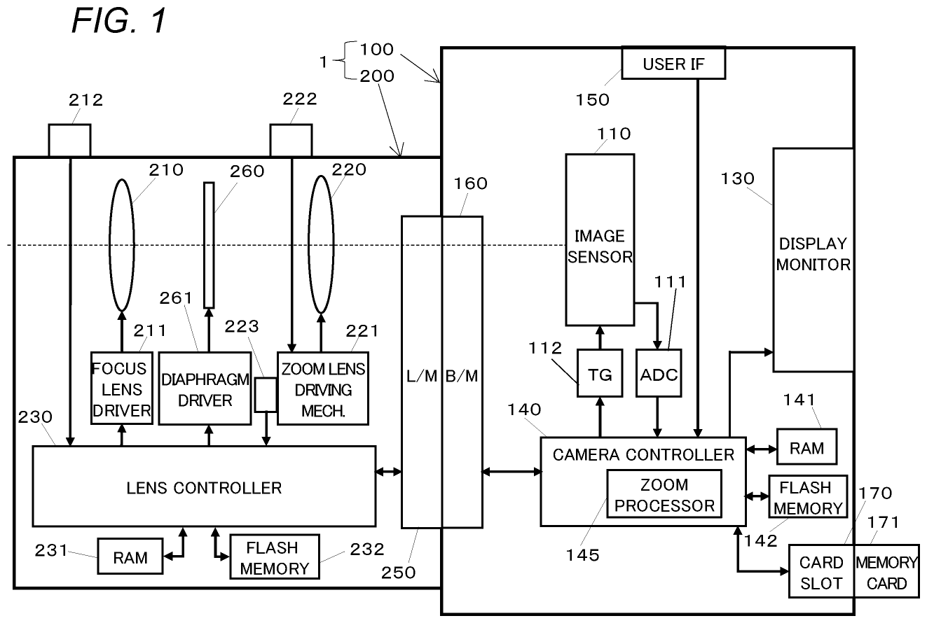

FIG. 1 is a block diagram showing a configuration of a digital camera 1 according to a first embodiment. The digital camera 1 of the present embodiment is constituted by a camera body 100 and an interchangeable lens 200 that is attachable to and detachable from the camera body 100.

### 1-1. Camera Body

The camera body 100 (an example of an imaging apparatus) includes an image sensor 110, a display monitor 130, a user interface 150, a camera controller 140, a RAM 141, a flash memory 142, a body mount 160, and a card slot 170. The camera body 100 also includes a zoom processor 145 that realizes an electronic zoom function as a functional configuration of the camera controller 140, for example.

The image sensor 110 is a device that captures a subject image incident through the interchangeable lens 200 and generates image data (also referred to as captured image data). For example, the image sensor 110 is a CMOS image sensor. The generated image data is digitized by an AD converter (ADC) 111. The digitized image data is subjected to predetermined image processing by the camera controller 140. For example, the predetermined image processing is gamma correction processing, white balance correction processing, flaw correction processing, YC conversion processing, electronic zoom processing, and JPEG compression processing. The image sensor 110 may be a CCD or NMOS image sensor, or the like.

The image sensor 110 operates at a timing controlled by a timing generator (TG) 112. The image sensor 110 generates a still image or a moving image for recording, or a live view image. The live view image is an example of a moving image displayed on the display monitor 130 to visualize a real-time imaging result by the image sensor 110 to the user.

The display monitor 130 is an example of a display that displays at least one of an image such as a live view image or various information such as a menu screen on a display screen. The display monitor 130 can be configured by various display devices such as a liquid crystal display device or an organic EL device. Additionally or alternatively to the display monitor 130, the digital camera 1 may include an electronic viewfinder (EVF) having a display screen as an example of another display in the camera body 100, for example.

The user interface 150 is a general term for user interfaces that allow a user to input an operation (instruction). When the user interface 150 receives an input of a user operation, the user interface 150 transmits an operation signal indicating various instructions according to the user operation to the camera controller 140. For example, the user interface 150 includes a physical button, a lever, a dial, a touch panel, a switch, and the like. The user interface 150 may also include virtual buttons and icons displayed on the display monitor 130. The user interface 150 is an example of a setting interface in the present embodiment.

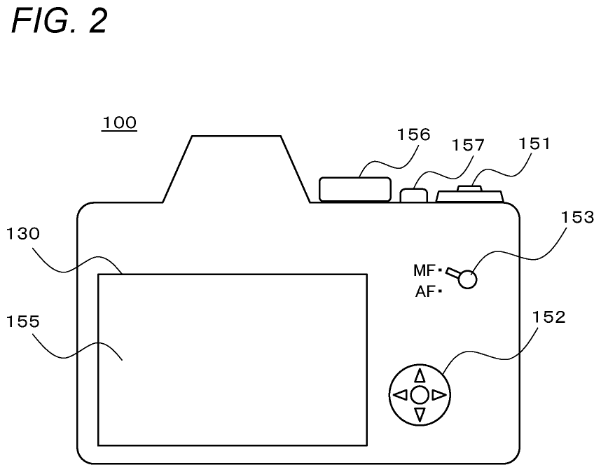

In FIG. 2, a release button 151, a direction button 152, a focus selection lever 153, a mode switching dial 156, a moving image recording button 157, and a touch panel 155 are illustrated as examples of the user interface 150 of the camera body 100. The user interface 150 can be used to operate a setting menu of the digital camera 1, for example. The user interface 150 is an example of a setting interface in the present embodiment.

The focus selection lever 153 is an example of a switcher that switches an operation mode related to a focusing operation in the setting interface of the digital camera 1. The focus selection lever 153 is configured to be switchable between two operation modes including a manual focus (MF) mode and an autofocus (AF) mode in the example of FIG. 2, but is not particularly limited thereto, and may be capable of switching between three or more operation modes. The operation mode to be switched may include an operation mode for various focusing operations, that is, a focus mode, such as a single AF (AF-S) mode and a continuous AF (AF-C) mode, or may include other operation modes.

The mode switching dial 156 is a dial-type operation member, and receives an operation of switching a shooting mode to be set in the digital camera 1 from among a plurality of shooting modes. The shooting mode is an operation mode for setting the digital camera 1 to an operation state for performing various image shooting, and includes a moving image shooting mode for shooting a moving image, for example. The plurality of shooting modes may further include a still image shooting mode for shooting a still image, or may include a shooting mode capable of shooting both a moving image and a still image.

The release button 151 is, for example, a two step pressing type operation member, and receives an instruction to capture an image. For example, the direction button 152 receives a selection operation in a setting menu of the digital camera 1. The moving image recording button 157 receives an operation of starting or ending the shooting and recording of a moving image.

Referring back to FIG. 1, the camera controller 140 controls the whole operation of the digital camera 1 by controlling the components such as the image sensor 110 in accordance with an instruction from the user interface 150. The camera controller 140 may be configured by a hard-wired electronic circuit, or may be configured by a microcomputer or the like that executes a program. The camera controller 140 transmits the vertical synchronization signal to the timing generator 112. In parallel with this, the camera controller 140 generates a synchronization signal synchronized with the vertical synchronization signal, and transmits the synchronization signal to the lens controller 230 via the body mount 160 and the lens mount 250. The camera controller 140 uses the RAM 141 as a work memory in a control operation or an image processing operation.

For example, the zoom processor 145 in the camera controller 140 executes zoom processing for implementing the electronic zoom function by image processing for cropping an image from the image data from the image sensor 110 and resizing the cropped image. The zoom processor 145 will be described in detail later. The zoom processor 145 is an example of an image processor according to the present exemplary embodiment. The zoom processor 145 is not limited to the functional configuration of the camera controller 140, and may be an image processing circuit separate from the camera controller 140, for example. The image cropping position is not limited to the vicinity of the center of the image. For example, the zoom processor 145 may crop a position selected by the user on the image.

The flash memory 142 stores programs and parameters used when the camera controller 140 performs control.

The body mount 160 can be mechanically and electrically connected to lens mount 250 of interchangeable lens 200. The body mount 160 can transmit and receive data to and from the interchangeable lens 200 via the lens mount 250. The body mount 160 transmits the exposure synchronizing signal received from the camera controller 140 to the lens controller 230 via the lens mount 250.

The body mount 160 also transmits other control signals received from the camera controller 140 to the lens controller 230 via the lens mount 250. The body mount 160 also transmits a signal received from the lens controller 230 via the lens mount 250 to the camera controller 140.

The card slot 170 can be mounted with the memory card 171, and controls the memory card 171 based on the control from the camera controller 140. The digital camera 1 can store image data in the memory card 171 and read image data from the memory card 171.

### 1-2. Interchangeable Lens

As shown in FIG. 1, the interchangeable lens 200 includes an optical system including, for example, a focus lens 210, a zoom lens 220, and a diaphragm 260. The interchangeable lens 200 further includes various drivers 211, 221, 261, a lens controller 230, a RAM 231, a flash memory 232, and a lens mount 250. The interchangeable lens 200 may further include an image stabilizer lens in addition to the lenses shown in FIG. 1.

The interchangeable lens 200 further includes operation members such as a focus ring 212 and a zoom ring 222. The operation member of the interchangeable lens 200 is not limited to this, and may include a lever provided on the exterior, for example.

The lens controller 230 controls the operation of the whole interchangeable lens 200. The lens controller 230 may be configured by a hard-wired electronic circuit, or may be configured by a microcomputer that executes a program, or the like.

The RAM 231 functions as a work memory used by the lens controller 230 during control. The flash memory 232 stores programs, parameters, lens data, and the like used for control by the lens controller 230.

The zoom lens 220 is a lens for changing the magnification of a subject image formed by the optical system of the interchangeable lens 200. The zoom lens 220 may have any number of lenses or any number of groups of lenses. The zoom lens drive mechanism 221 is a mechanical mechanism (e.g., a cam mechanism) that moves the zoom lens 220 along the optical axis of the optical system based on the operation of the zoom ring 222 by the user. The position of the zoom lens 220 is detected by a zoom lens position detector 223 as needed, and is notified to the lens controller 230. The devices 220 to 223 for such optical zoom are an example of an optical zoom mechanism in the camera body 100.

The zoom ring 222 has a predetermined angle range (e.g., 90 degrees) in which the optical focal length of the zoom lens 220 in the interchangeable lens 200 is movable between a wide-angle end at which the optical focal length is the shortest and a telephoto end at which the optical focal length is the longest. The zoom ring 222 is an example of an operation member that can perform a zoom operation by being operated to various rotation angles within the angle range.

The diaphragm 260 adjusts the amount of light incident on the image sensor 110. The diaphragm 260 is driven by a diaphragm driver 261, and the size of the aperture thereof is controlled. The diaphragm driver 261 includes a motor or an actuator.

The focus lens 210 is a lens for changing a focus state of a subject image that is incident from the optical system and formed on the image sensor 110. The focus lens 210 may have any number of lenses or any number of groups of lenses. The focus lens driver 211 drives the focus lens 210 to move forward and backward along the optical axis of the optical system based on the control of the lens controller 230. For example, the focus lens driver 211 can be implemented by a stepping motor, a DC motor, an ultrasonic motor, a linear motor, or the like.

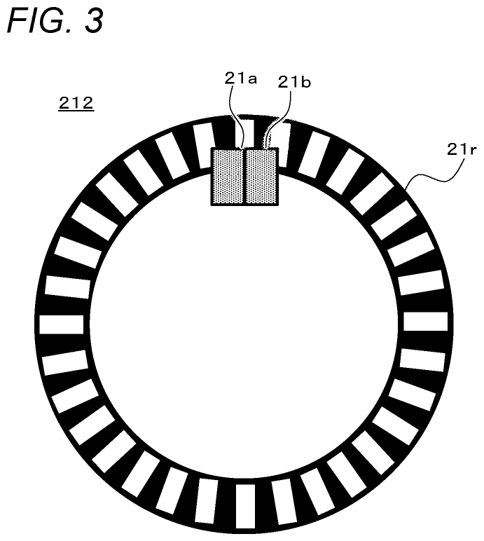

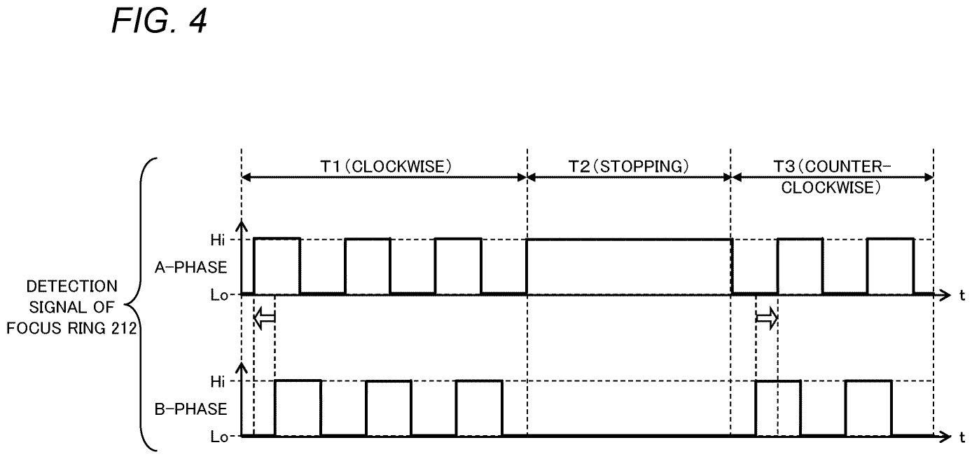

The focus ring 212 is an operation member provided to adjust the focus position of the digital camera 1 by changing the position of the focus lens 210 along the optical axis in the interchangeable lens 200. The focus ring 212 will be described in detail with reference to FIGS. 3 and 4.

### 1-2-1. Focus Ring

FIG. 3 illustrates a configuration of the focus ring 212 in the interchangeable lens 200 of the digital camera 1. For example, the focus ring 212 includes a ring member 21r provided along the outer periphery around the optical axis of the interchangeable lens 200, an A-phase photointerrupter 21a, and a B-phase photointerrupter 21b.

For example, a plurality of slits are periodically provided in the circumferential direction in the 21r of the ring member, and thus periodic light shielding portions and light transmitting portions are formed, as shown in FIG. 3. The ring member 21r of the focus ring 212 is configured to be rotatable without limitation of an angle range, for example. Alternatively, the ring member 21r may be configured to be rotatable within a predetermined limited angular range.

The A-phase photointerrupter 21a and the B-phase photointerrupter 21b are arranged at positions having a phase shift of ¼ cycle from each other in the arrangement cycle of the slits in the ring member 21r (see FIG. 4). Each of the photointerrupters 21a and 21b includes a light emitting portion and a light receiving portion facing each other via the ring member 21r. Each of the photointerrupters 21a and 21b generates a detection signal by receiving light from the light emitter by the light receiver, and outputs the detection signal to the lens controller 230.

FIG. 4 is a timing chart illustrating a detection signal of the focus ring 212 in the interchangeable lens 200. FIG. 4 shows the timing of the detection signal from the A-phase photointerrupter 21a and the timing of the detection signal from the B-phase photointerrupter 21b in the focus ring 212. FIG. 4 illustrates the detection signals when the focus ring 212 is rotated, for example, clockwise in the period T1, stopped in the period T2, and rotated in the opposite direction, for example, counterclockwise in the period T3.

For example, the detection signal of the focus ring 212 has a signal level such as a high level Hi or a low level Lo, as illustrated in FIG. 4. The high level Hi of the detection signal indicates a state in which the corresponding photointerrupters 21a and 21b face the light transmitting portion of the ring member 21r, and the low level Lo indicates a state in which the corresponding photointerrupters 21a and 21b face the light shielding portion of the ring member 21r.

As shown in FIG. 4, in the period T1 in which the focus ring 212 is rotated forward, the pulse waveform of the detection signal is formed in the phase that precedes the A-phase by ¼ cycle, for example. In the period T2 in which the focus ring 212 is stopped, the signal level of each detection signal is constant. In the period T3 in which the focus ring 212 is rotated in the reverse direction, the pulse waveform of the detection signal is formed in the phase in which the B-phase precedes, contrary to the period T1. Based on the detection signal of the focus ring 212, the lens controller 230 can detect various rotation states of the focus ring 212.

For example, the lens controller 230 counts the number of pulses in the detection signal of the focus ring 212, for example, by setting clockwise rotation as positive and counterclockwise rotation as negative. The rotational position of the focus ring 212 can be detected from the counting result. For example, in the MF mode, the lens controller 230 controls the focus lens driver 211 to drive the focus lens 210 according to the counted number of pulses. According to such an MF function, the focus position of the digital camera 1 can be adjusted according to the degree of operation of the focus ring 212 by the user.

### 2. Operation

The operation of the digital camera 1 configured as described above will be described below.

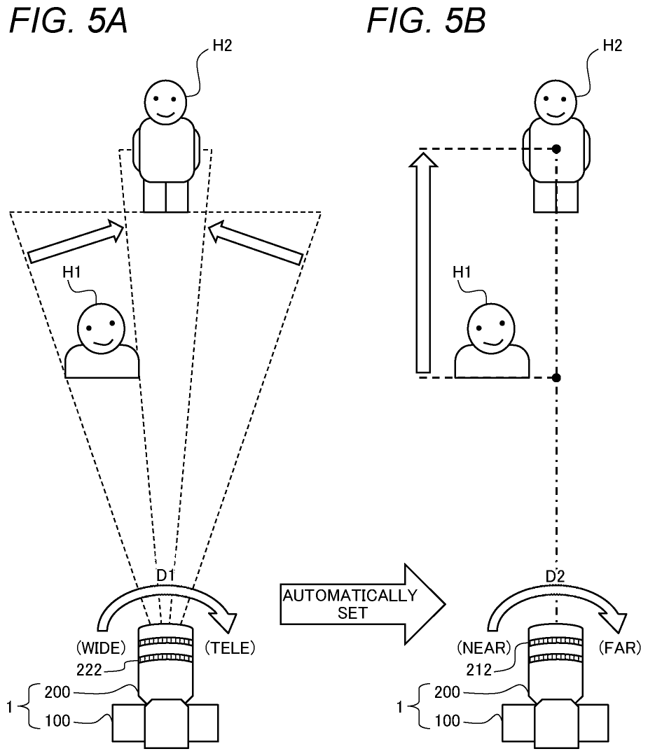

FIGS. 5A and 5B are diagrams for explaining an outline of the operation of the digital camera 1 in the present embodiment. FIGS. 5A and 5B illustrate a shooting scene including a subject H1 at a relatively short distance from the digital camera 1 and a subject H2 at a relatively long distance from the digital camera 1.

FIG. 5A shows an example of a zoom operation of the digital camera 1 in such a shooting scene. FIG. 5B shows an example of the focus operation of the digital camera 1 in the same shooting scene as in FIG. 5A.

In the example of FIG. 5A, by a zoom operation of rotating the zoom ring 222 clockwise (as viewed from the photographer), the angle of view of the digital camera 1 is narrowed from the wide-angle side including a plurality of subjects H1 and H2 to the telephoto side including only a far subject H2. In this way, the zoom-in operation for increasing the zoom magnification or the zoom-out operation for decreasing the zoom magnification by the reverse rotation of the zoom ring 222 is realized according to the operation direction D1 set in advance in the interchangeable lens 200.

Hereinafter, the operation direction D1 in the example of FIG. 5A is referred to as “normal rotation” of the zoom ring 222, and the operation direction D1 opposite to the present example is referred to as “reverse rotation”. For example, when using the interchangeable lens 200 whose operation direction D1 is “reverse rotation”, the user can perform the same zoom-in as in this example by rotating the zoom ring 222 counterclockwise, which is opposite to the example of FIG. 5A. The operation direction D1 of the zoom ring 222 is typically set in various ways depending on a lens manufacturer or a mount system, for example.

FIG. 5B illustrates a focus operation of shifting the focus from the near subject H1 to the far subject H2 at the same time as the zoom operation in FIG. 5A. In such a focus operation, the orientation for which the focus ring 212 is rotated is determined according to the operation direction D2 set for the focus ring 212.

In the digital camera 1, for example, moving image shooting may be performed using both a zoom operation and a focus operation. For example, as shown in FIGS. 5A and 5B, the focus may often be shifted from the near subject H1 to the far subject H2 with zooming-in, or conversely, the focus may be often shifted from the far subject H2 to the near subject H1 with zooming-out. At this time, if the orientation of rotation of each ring 222, 212 is different between the zoom operation and the focus operation, the camera user can be hard for handling the operation.

Therefore, the digital camera 1 of the present embodiment detects the operation direction D1 of the zoom ring 222 in the interchangeable lens 200 mounted in the camera body 100, for example, and automatically switches and sets the operation direction D2 of the focus ring 212 in accordance with the detected operation direction D1 as shown in FIGS. 5A and 5B.

In the example of FIG. 5B, at the operation direction D2 of the focus ring 212 in the operation direction, the focusing position is moved away by the clockwise rotation, and the focusing position is moved closer by the counterclockwise rotation. Hereinafter, the operation direction D2 in the example of FIG. 5B is referred to as “normal rotation” of the focus ring 212, and the operation direction D2 opposite to the operation direction in this example is referred to as “reverse rotation”.

As described above, the digital camera 1 of the present embodiment can facilitate the user to perform the operations of the digital camera 1, which are the zoom operation and the focus operation, by interlocking the operation directions D1 and D2 of the rings 222, 212 in the interchangeable lens 200. Hereinafter, the operation of the digital camera 1 according to the present embodiment will be described in detail.

### 2-1. MF Setting Process

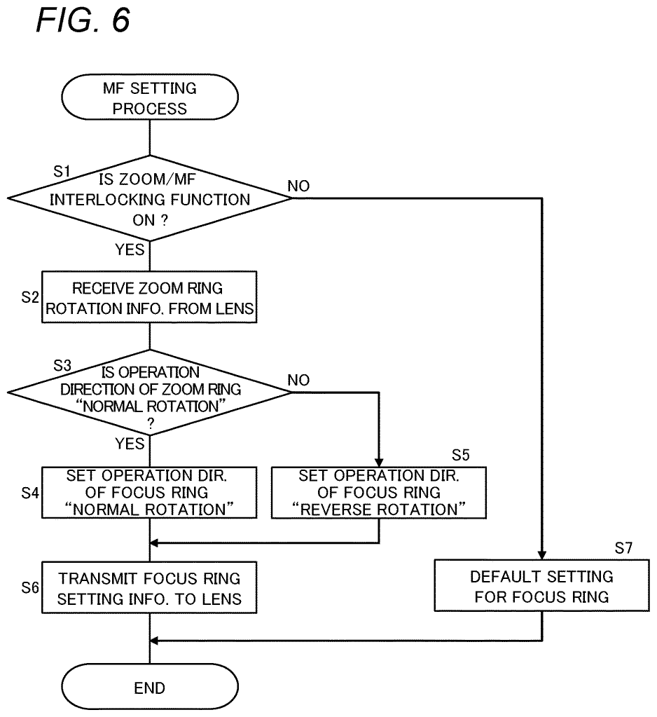

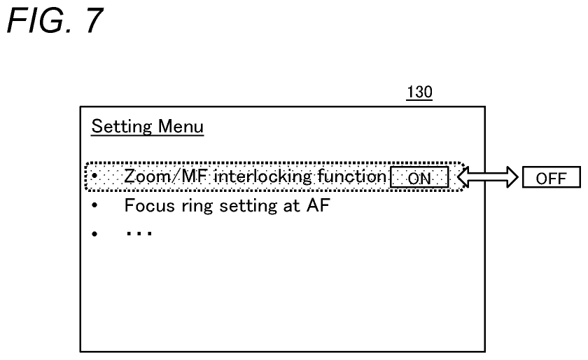

Processing for setting the operation direction D2 of the focus ring 212 for a manual focus (MF) operation for adjusting the focus in accordance with a focus operation in the digital camera 1 of the present embodiment will be described with reference to FIGS. 6 and 7.

FIG. 6 is a flowchart illustrating an example of the MF setting process in the digital camera 1 of the present embodiment. The processing illustrated in the flow of FIG. 6 is executed by the camera controller 140 with the interchangeable lens 200 being attached to the camera body 100 of the digital camera 1, for example.

First, the camera controller 140 determines whether or not the zoom/MF interlocking function is in the ON state (S1). The zoom/MF interlocking function is a function of interlocking the operation direction D1 of the zoom ring 222 and the operation direction D2 of the focus ring 212 in the MF operation. Such a zoom/MF interlocking function can be set in a setting menu of the digital camera 1, for example.

FIG. 7 shows a display example of a setting menu in the digital camera 1 of the present embodiment. For example, the display monitor 130 of the digital camera 1 displays a setting menu including setting items such as “zoom/MF interlocking function” and “focus ring setting at AF”, as shown in FIG. 7.

The user of the digital camera 1 can switch the zoom/MF interlocking function between an ON state in which the zoom/MF interlocking function is enabled and an OFF state in which the zoom/MF interlocking function is disabled in such setting items by operating the setting menu from the direction button 152 or the touch panel 155 (FIG. 2) of the user interface 150, for example. For example, the camera controller 140 receives a user operation on the setting menu as illustrated in FIG. 7 via the user interface 150, to determine the step S1. Alternatively, in the digital camera 1, information set in the setting menu in the past may be stored in the flash memory 142, and the process of step S1 may be performed by referring to such setting information.

For example, when the zoom/MF interlocking function is in the ON state (YES in S1), the camera controller 140 receives information for managing the operation direction D1 of the zoom ring 222 (i.e., zoom ring rotation information) from the interchangeable lens 200 mounted on the camera body 100 (S2). The processing of step S2 is performed for detecting the operation direction D1 of the zoom ring 222 in the camera body 100, using communication with the interchangeable lens 200 mounted on the camera body 100, for example.

For example, the camera controller 140 requests the zoom ring rotation information from the interchangeable lens 200 via the body mount 160, and receives the zoom ring rotation information from the interchangeable lens 200 via the body mount 160 (S2). Alternatively, in the digital camera 1, information indicating a correspondence between identification information of various interchangeable lenses and the operation direction D1 may be stored in the flash memory 142 in advance, and the camera controller 140 may receive the identification information of the mounted interchangeable lens 200 in step S2. In this case, the operation direction D1 can be detected by collation with the stored information. The camera controller 140 may hold information received in initial communication with the interchangeable lens 200 at the time of mounting or the like in the RAM 141, and refer to the held information in the step S2.

Next, the camera controller 140 determines whether the operation direction D1 of the zoom ring 222 is the normal rotation or the reverse rotation, based on the detected operation direction D1 of the zoom ring 222, for example (S3). The determination of the step S3 can be performed by detecting the orientation of the rotation operation of the zoom ring 222 corresponding to either the zoom-in or the zoom-out, for example.

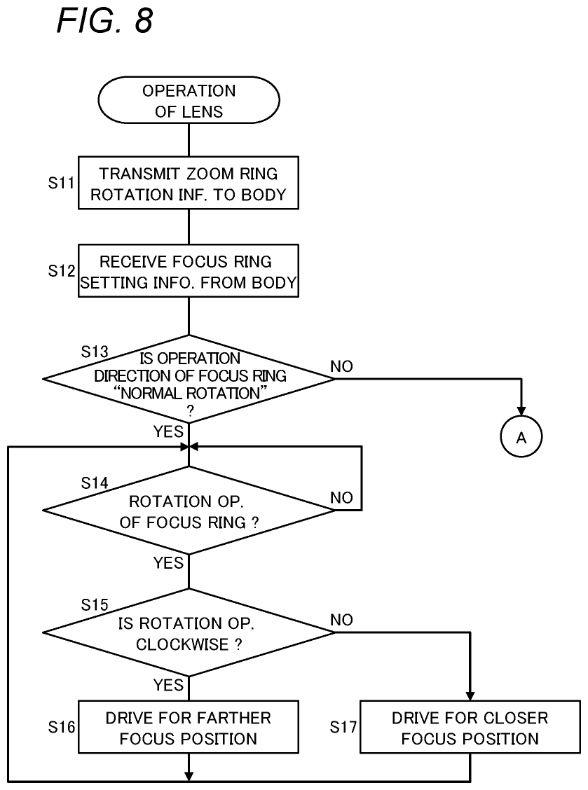

When the camera controller 140 determines that the operation direction D1 of the zoom ring 222 is the normal rotation (YES in S3), the camera controller 140 sets the operation direction D2 of the focus ring 212 to “normal rotation” (S4). According to the setting “normal rotation” of the step S4, as in the example shown in FIG. 5B, the operation parameters of the MF operation are set such that the clockwise rotation operation of the focus ring 212 moves the focus position away and the counterclockwise operation moves the focus position closer (see FIG. 8).

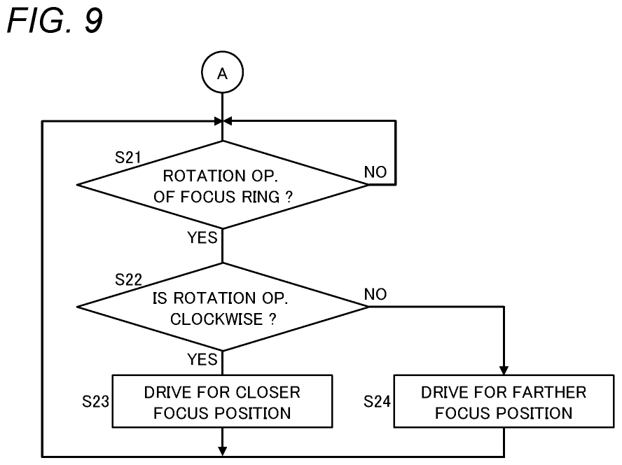

On the other hand, when the camera controller 140 determines that the operation direction D1 of the zoom ring 222 is the reverse rotation and is not the normal rotation (NO in S3), the camera controller 140 sets the operation direction D2 of the focus ring 212 to “reverse rotation” (S5). According to the setting “reverse rotation” of the step S5, contrary to the example of FIG. 5B, the operation parameters of the MF are set such that the clockwise rotation operation of the focus ring 212 moves the focus position closer and the counterclockwise operation moves the focus position away (see FIG. 9).

Next, the camera controller 140 transmits focus ring setting information indicating the operation direction D2 of the focus ring 212 set in either step S4 or S5, for example, to the interchangeable lens 200 via the body mount 160 (S6). Accordingly, in the interchangeable lens 200, the MF operation is performed in accordance with the operation direction D2 indicated by the focus ring setting information (see FIGS. 8 and 9).

Further, when the zoom/MF interlocking function is in the OFF state (NO in S1), the camera controller 140 adopts a predetermined default setting for the setting of the operation direction D2 of the focus ring 212, for example (S7). For example, the information of the default setting is stored in advance in the flash memory 232 of the interchangeable lens 200. For example, the camera controller 140 receives the information of the default setting from the interchangeable lens 200 via the body mount 160, and sets the operation direction D2 of the focus ring 212 to the normal rotation or the reverse rotation according to the received information (S7).

After the processes of steps S6 and S7, the camera controller 140 ends the MF setting process shown in FIG. 6, for example.

According to the MF setting process described above, in the digital camera 1 of the present embodiment, the camera controller 140 detects the operation direction D1 of the interchangeable lens 200 mounted on the camera body 100 (S2), and sets the operation direction D2 of the focus ring 212 according to the detection result (S4, S5). Accordingly, in the digital camera 1 of the present embodiment, the operation direction D2 of the MF operation by the focus ring 212 is matched with the operation direction D1 of the zooming operation by the zoom ring 222, and the user can easily operate the digital camera 1.

### 2-2. Operation of Interchangeable Lens

The operation of the interchangeable lens 200 in the digital camera 1 of the present embodiment will be described with reference to FIGS. 8 and 9.

FIGS. 8 and 9 are flowcharts illustrating the operation of the interchangeable lens in the digital camera 1 of the present embodiment. An operation example of the MF operation of the interchangeable lens 200 of the digital camera 1 will be described below in the case where the zoom/MF interlocking function is ON (YES in S1). The processing illustrated in the flow of FIGS. 8 and 9 is started when the zoom ring rotation information is requested from the camera body 100 in step S2 of FIG. 6. Each processing shown in this flow is executed by the lens controller 230 of the interchangeable lens 200, for example.

First, in the interchangeable lens 200 in the digital camera 1, the lens controller 230 transmits zoom ring rotation information indicating the operation direction D1 of the zoom ring 222 to the camera body 100 via the lens mount 250, for example (S11). For example, the lens controller 230 reads zoom ring rotation information stored in advance in the flash memory 232 of the interchangeable lens 200 in response to a request (S2 in FIG. 6) from the camera body 100 to which the interchangeable lens 200 is attached, and transmits the zoom ring rotation information to the camera body 100 (S11).

By such step S11, the interchangeable lens 200 can cause the camera body 100 to detect the operation direction D1 of the zoom ring 222 based on the zoom ring rotation information (S2). The lens controller 230 may transmit various information such as identification information of the interchangeable lens 200 to the camera body 100 instead of the zoom ring rotation information of the step S11.

Thereafter, in the camera body 100, the operation direction D2 of the focus ring 212 is set (S4, S5) according to the operation direction D1 of the zoom ring 222, to transmit focus ring setting information indicating such a setting result to the interchangeable lens 200 (S6). In the interchangeable lens 200, the lens controller 230 receives the focus ring setting information from the camera body 100 via the lens mount 250 (S12).

Next, the lens controller 230 determines whether the set operation direction D2 of the focus ring 212 is “normal rotation” or “reverse rotation” based on the received focus ring setting information (S13). The determination of the step S13 can be performed by detecting the direction of the rotation operation of the focus ring 212 corresponding to any one of the focus operations of moving the focus position away from or toward the focus position, for example.

When the set operation direction D2 of the focus ring 212 is “normal rotation” (YES in S13), the lens controller 230 controls the MF operation according to the setting “normal rotation” of the operation direction D2 (S14 to S17).

For example, the lens controller 230 first determines whether or not a rotation operation (i.e., a focus operation) by the user is input in the focus ring 212, based on a detection signal from the focus ring 212, for example (S14). When no user operation is input to the focus ring 212 (NO in S14), the lens controller 230 repeats the determination of step S14 periodically, for example.

When the rotation operation of the focus ring 212 is input (YES in S14), the lens controller 230 determines whether the direction of the input rotation operation is the clockwise direction or the counterclockwise direction of the focus ring 212, for example (S15). For example, the lens controller 230 counts the number of pulses corresponding to the rotation operation detected in the detection signal from the focus ring 212 as the operation amount, and proceeds to YES in step S15 when the sign of the operation amount is positive, and proceeds to NO when the sign is negative.

When the direction of the input rotation operation is the clockwise direction of the focus ring 212 (YES in S15), the lens controller 230 performs the drive control of the focus lens 210 according to the setting “normal rotation” (YES in S13) of the operation direction D2 (S16). In the step S16, the MF operation of moving the focus position farther is executed as illustrated in FIG. 5B by the amount of the rotation operation of the focus ring 212.

In step S16, based on the positive sign of the operation amount of the focus ring 212 and the setting “normal rotation” of the operation direction D2, the lens controller 230 sets the sign of the driving amount to a sign (e.g., positive) corresponding to the far side of the far side and the near side of the focus position, for example. Further, based on the magnitude (i.e., the absolute value) of the operation amount, the lens controller 230 calculates the magnitude of the driving amount of the focus lens driver 211, to instruct the focus lens driver 211 about the driving amount.

In step S16, the focus lens driver 211 drives the focus lens 210 so that the focus lens position moves from the closest end toward the infinity end by the driving amount instructed from the lens controller 230. The driving amount of the focus lens driver 211 corresponds to the amount of change in the operation parameter of the MF. The operation parameter of the MF may be various parameters indicating the focus position, and may be the position of the focus lens 210, for example. For example, the lens controller 230 can manage such MF operation parameters in the RAM 231, or transmit the MF operation parameters to the camera body 100 via the lens mount 250.

On the other hand, when the direction of the input rotation operation is the counterclockwise direction of the focus ring 212 (NO in S15), the lens controller 230 controls the focus lens driver 211 so as to bring the focus position closer in accordance with the setting “normal rotation” of the operation direction D2 (S17).

In step S17, the lens controller 230 calculates a driving amount having a sign opposite to that of step S16 in the same manner as described above, based on the negative sign of the operation amount of the focus ring 212 and the setting of the operation direction D2 which is the same as that of step S16, for example. The focus lens driver 211 drives the focus lens 210 so that the focus lens position moves from the infinity end toward the closest end by the driving amount calculated in this manner.

The lens controller 230 repeats the processing of step S16 and subsequent steps after the control (S14, S17) of the focus lens driver 211, for example. In this way, the MF control is performed in the setting in which the operation direction D2 of the focus ring 212 is “normal rotation” (YES in S13).

When the set operation direction D2 of the focus ring 212 is “reverse rotation” (NO in S13), the lens controller 230 performs the MF control according to the setting of “reverse rotation” (S21 to S24), for example, as illustrated in FIG. 9. The MF control (S21 to S24) in the setting “reverse rotation” of the operation direction D2 of the focus ring 212 is performed so as to drive the focus lens 210 in the opposite direction to the input user operation in the same processing as the steps S14 to S17 in the case of “normal rotation”.

For example, the lens controller 230 receives a rotation operation of the focus ring 212 (S14), and in response to the input of the rotation operation (YES in S21), the lens controller 230 determines the direction of the input rotation operation (S21), similarly to the steps S22 and S15.

When the direction of the input rotation operation is the clockwise direction of the focus ring 212 (YES in S22), the lens controller 230 controls the focus lens driver 211 so as to bring the focus position closer according to the setting “reverse rotation” of the operation direction D2 (S23).

In step S23, the lens controller 230 calculates a driving amount having a sign opposite to that of step S16, based on the sign of the operation amount similar to that of step S16 and the setting “reverse rotation” (NO in S13) of the operation direction D2, for example. In this way, the focus lens driver 211 drives the focus lens 210 toward the closest end by the driving amount, as in the step S17.

On the other hand, when the direction of the input rotation operation is counterclockwise (NO in S22), the lens controller 230 controls the focus lens driver 211 so as to move the focus position away according to the setting “reverse rotation” of the operation direction D2 (S24).

In step S24, the lens controller 230 calculates a driving amount having a sign opposite to that of step S17, based on the sign of the operation amount similar to that of step S17 and the setting “reverse rotation” of the operation direction D2, for example. In this way, the focus lens 210 is driven by the focus lens driver 211 in the same manner as in the step S16.

The lens controller 230 repeats the processing of step S23 and subsequent steps after the control (S21, S24) of the focus lens driver 211, for example. In this way, the MF control is performed in the setting of “reverse rotation” (NO in S13) of the operation direction D2 of the focus ring 212.

According to the above processing, in the digital camera 1 of the present embodiment, the interchangeable lens 200 causes the camera body 100 to detect the operation direction D1 of the zoom ring 222 (S31), and acquires the setting of the operation direction D2 of the focus ring 212 from the camera body 100 (S32), for example. The interchangeable lens 200 of the present embodiment reflects such settings from the camera body 100 to execute the MF operation matching with the focus operation by the user (S14 to S24). Accordingly, the interchangeable lens 200 of the present embodiment can facilitate the operation using each ring 212, 222.

In the interchangeable lens 200 of the present embodiment, when the zoom ring 222 is operated by the user during the MF operation described above, the optical zooming mechanism operates in accordance with the operation direction D1. For example, the zoom driver 221 drives the zoom lens 220 according to the operation amount of the zoom ring 222, and the operation parameter, such as a zoom magnification in optical zoom, changes. At this time, the lens controller 230 sequentially updates and manages the optical zooming operation parameters in the RAM 231, for example. The operation parameter of the optical zoom may be various parameters indicating a zoom magnification, and may be a position of the zoom lens 220, a focal length or an angle of view of the interchangeable lens 200, for example. The lens controller 230 may transmit the operation parameters of the optical zoom to the camera body 100 via the lens mount 250 as needed.

In the digital camera 1 of the present embodiment, the above processing is an example, and various modifications are possible. For example, instead of the step S13 described above, the lens controller 230 may determine whether or not the set operation direction D2 of the focus ring 212 is the same as the default setting. Alternatively, in the digital camera 1 of the present embodiment, the camera controller 140 may transmit the focus ring setting information only when the set operation direction D2 of the focus ring 212 is different from the default setting of the interchangeable lens 200, for example. When such focus ring setting information is received, the lens controller 230 may adopt the operation direction D2 opposite to the default setting.

### 3. Review

As described above, the digital camera 1 and the camera body 100, which are examples of the imaging apparatus of the present embodiment, each include the image sensor 110, which is an example of the image sensor, and the camera controller 140, which is an example of the controller. The image sensor 110 captures a subject image via an optical system included in the interchangeable lens 200, for example, and generates image data. The camera controller 140 controls an operation of the interchangeable lens 200. The interchangeable lens 200 is provided with a zoom ring 222, which is an example of a first operation member for changing an optical zoom operation parameter as an example of a first operation parameter, and a focus ring 212, which is an example of a second operation member for changing an MF operation parameter as an example of a second operation parameter. The camera controller 140 detects a first operation direction D1 in which a user operation on the first operation member is associated with a change in the first operation parameter (S2), and sets a second operation direction in the second operation member so as to change the second operation direction D2 in which a user operation on the second operation member is associated with a change in the second operation parameter in accordance with the detected first operation direction (S4 to S6).

According to the above imaging apparatus, the operation directions D1 and D2 of the operation members such as the rings 222 and 212 in the interchangeable lens 200 are automatically aligned, and it is possible to facilitate operating the digital camera 1 using such operation members.

In the present embodiment, the second operation member such as the focus ring 212 may have a plurality of options that can be set in the second operation direction such as “normal rotation” or “reverse rotation”. The camera controller 140 may switch the second operation direction among the plurality of options according to the detected first operation direction and set the second operation member. This makes it possible to easily operate the operation member provided in the optical system in the digital camera 1.

In the present embodiment, the first operation parameter indicates a zoom magnification based on optical zoom by the interchangeable lens 200 in the digital camera 1. The second operation parameter indicates a focus position by the interchangeable lens 200. The camera controller 140 changes the second operation direction D2 in accordance with the detected first operation direction D1 so that an orientation for which the focus position is moved away in the second operation direction matches an orientation for which the zoom magnification increases in the first operation direction D1. The camera controller 140 may change the second operation direction D2 so that an orientation for which the focus position is made closer in the second operation direction D2 matches an orientation for which the zoom magnification is decreased in the first operation direction D1. In this way, the digital camera 1 of the present embodiment can automatically align the respective operation directions D1 and D2 of the optical zooming and the MF operation, and can make it easy to operate the respective operation members.

In the present embodiment, the zoom ring 222, which is an example of a first operation member, is an operation ring that is provided in an annular shape around the optical system of the interchangeable lens 200 and is rotatable about the optical axis of the optical system. The focus ring 212, which is an example of a second operation member, is an operation ring that is provided in an annular shape around the optical system separately from the first operation member and is rotatable about the optical axis. The camera controller 140 detects the first operation direction D1 in the direction in which the first operation member rotates, and changes the second operation direction D2 in the direction in which the second operation member rotates. Accordingly, the imaging apparatus of the present embodiment can align the operation directions D1 and D2 in which the rings 222, 212 and rotate, and can facilitate such a rotation operation.

In the present embodiment, the optical system and the first and second operation members constitute an interchangeable lens 200 that is detachably attached to the camera body 100. The camera body 100 further includes a body mount 160, which is an example of a communication interface that performs data communication with the mounted interchangeable lens 200. The camera controller 140 detects the first operation direction by data communication with the interchangeable lens 200 via the body mount 160. This makes it possible to easily operate the operation member provided in the interchangeable lens 200 in the digital camera 1 of the lens interchangeable type.

In the present embodiment, the camera controller 140 transmits focus ring setting information, which is an example of setting information indicating the second operation direction D2, to the interchangeable lens 200 via the body mount 160 so as to set the second operation direction D2 in the second operation member in accordance with the detected first operation direction D1 (S6). Accordingly, the digital camera 1 of the present embodiment can facilitate the operation of the operation member using the operation direction of the interchangeable lens 200 set in the camera body 100.

In the present embodiment, a control method for controlling an operation by an optical system of an imaging apparatus is provided. The optical system is provided with a first operation member for changing the first operation parameter and a second operation member for changing the second operation parameter. The method includes a step (S2) of detecting, by the camera controller 140 as an example of a controller of the imaging apparatus, a first operation direction in which a user operation on a first operation member is associated with a change in a first operation parameter, and a step (S4 to S6) of setting a second operation direction in a second operation member so as to change the second operation direction in which a user operation on the second operation member is associated with a second operation parameter, in accordance with the detected first operation direction.

According to the above control method, it is possible to facilitate the operation using the operation member provided in the optical system. The controller of the imaging apparatus that executes the present method is not necessarily limited to the camera controller 140, and may be the lens controller 230, or may be realized by cooperation of the controllers 140, 230.

In the present embodiment, a program for causing a processor such as the camera controller 140 to execute the control method as described above is provided. Such a program may be included in a program product, may be provided via a portable storage medium, or may be provided via a communication network such as the Internet.

In the present embodiment, an interchangeable lens 200 that can be detachably mounted on a camera body 100 is provided. The interchangeable lens 200 includes a lens mount 250, which is an example of a communication interface, an optical system (210, 220), a zoom ring 222, which is an example of a first operation member, a focus ring 212, which is an example of a second operation member, and a lens controller 230, which is an example of a controller. The lens mount 250 performs data communication with the camera body 100 mounted thereon. The optical system forms an image on the image sensor 110 of the camera body 100 based on incident light. The first operating member changes the first operating parameter. The second operating member changes the second operating parameter. The lens controller 230 controls the operation of the optical system based on information received from the camera body 100 via the lens mount 250. The lens controller 230 causes the imaging apparatus to detect a first operation direction in which a user operation on the first operation member is associated with a change in the first operation parameter (S11) by communicating with the camera body 100 via the lens mount 250. The lens controller 230 receives setting information indicating a second operation direction that associates a user operation on the second operation member with a change in the second operation parameter from the camera body 100 via the lens mount 250 (S12), receives the user operation on the second operation member, and operates the optical system so as to change the second operation parameter in accordance with the second operation direction indicated by the setting information (S14 to S24). Accordingly, the interchangeable lens 200 of the present embodiment can facilitate operating the provided operation member.

### Second Embodiment

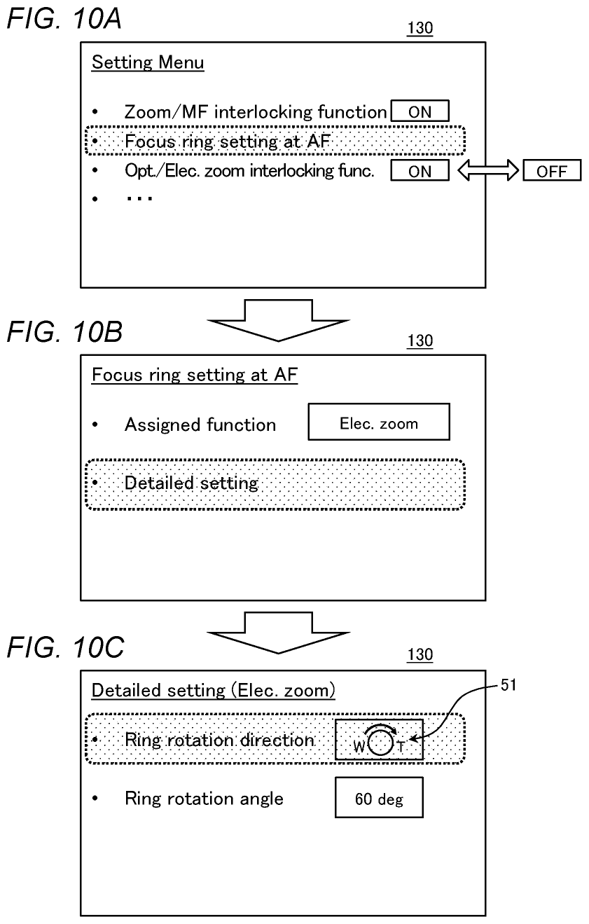

Hereinafter, a second embodiment of the present disclosure will be described with reference to FIGS. 10A to 12. In the first embodiment, the digital camera 1 that automatically sets the operation direction D2 of the MF operation according to the operation direction D1 of the optical zooming has been described. In the second embodiment, a digital camera 1 that automatically sets an operation direction of electronic zoom will be described.

Hereinafter, the digital camera 1 according to the present embodiment will be described, omitting the description of the same configuration and operation as those of the digital camera 1 according to the first embodiment as appropriate.

### 1. Focus Ring Setting of Electronic Zoom Function

FIGS. 10A to 10C show a display example of a setting menu in the digital camera 1 of the second embodiment. In the digital camera 1 of the present embodiment, the electronic zoom function can be assigned to an operation member such as the focus lens 210 of the interchangeable lens 200 by user selection in a setting menu, for example. This can facilitate the user to use the electronic zoom.

FIG. 10A shows a display example of a setting menu screen in the digital camera 1 of the present embodiment. The digital camera 1 displays the setting menu screen on the display monitor 130 in accordance with a user operation for calling a setting menu in the user interface 150, for example. In the digital camera 1 of the present embodiment, the setting menu screen includes setting items such as “focus ring setting at AF” and “optical/electronic zoom interlocking function” as shown in FIG. 10A, for example.

The digital camera 1 of the present embodiment performs setting for assigning various functions to the focus ring 212 in accordance with a user operation on the user interface 150 for the setting item “focus ring setting at AF” on the setting menu screen, for example. Accordingly, the focus ring 212 used for the MF operation in the MF mode can be effectively used in the AF mode. FIG. 10B illustrates a display example to which the setting menu screen in FIG. 10A transitions when the setting item is selected.

FIG. 10B illustrates a function setting screen of the focus ring 212 for the AF mode in the digital camera 1 of the present embodiment. The present setting screen includes setting items such as “assigned function” indicating a function assigned to the focus ring 212 and “detailed setting” for setting details of the assigned function.

In the present embodiment, an operation example will be described below in the case where the electronic zoom function is assigned to the focus ring 212 in the digital camera 1 as illustrated in FIG. 10B. For example, even if the interchangeable lens 200 in use is a single-focus lens that does not have an optical zoom function, the user can use the electronic zoom function as if the interchangeable lens 200 were a zoom lens by utilizing the focus ring 212. FIG. 10C illustrates a display example to which the screen transitions when the setting item “detailed setting” is selected from the function setting screen illustrated in FIG. 10B.

FIG. 10C illustrates a detailed setting screen of the electronic zoom function in the digital camera 1 of the present embodiment. For example, the present setting screen includes setting items such as “ring rotation direction” and “ring rotation angle”, as illustrated in FIG. 10C. The various setting contents in FIG. 10C are examples of setting information input by the user.

For example, the digital camera 1 of the present embodiment may receive a detailed setting desired by the user for the operation of the focus ring 212 to which the electronic zoom function is assigned, and execute the electronic zoom operation according to such a user setting, as shown in FIG. 10C. Accordingly, the digital camera 1 of the present embodiment can make it easy for the user to use the electronic zoom function using the focus ring 212. For example, according to the detailed settings of the focus ring 212, the user can use the electronic zoom function as if using a familiar zoom lens.

### 2. Electronic Zoom Setting Process

For example, the digital camera 1 of the present embodiment performs automatic setting of the operation direction according to the interchangeable lens 200 mounted on the camera body 100 for the electronic zoom operation assigned to the focus ring 212 as described above, similarly to the MF operation of the first embodiment.

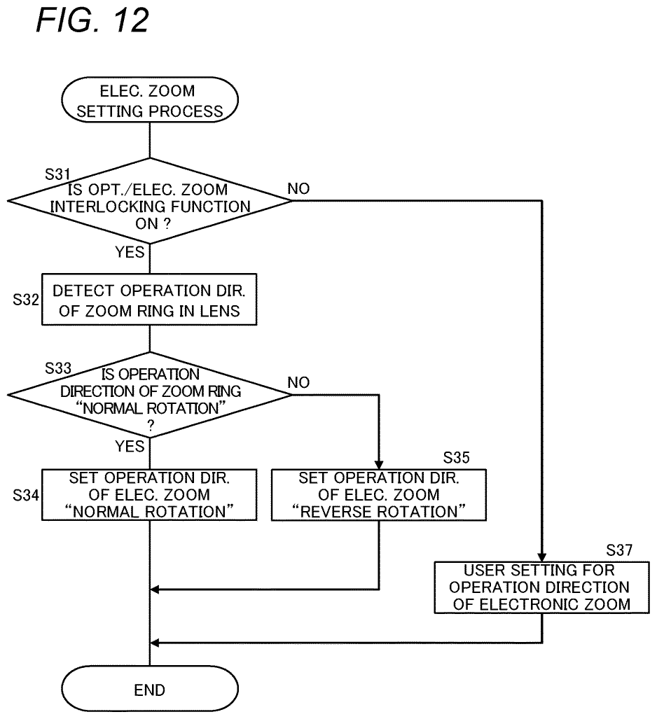

FIG. 12 is a flowchart illustrating an example of electronic zoom setting process in the digital camera 1 according to the second embodiment. For example, the processing illustrated in the flow of FIG. 12 is executed by the camera controller 140, similarly to the MF setting process of the first embodiment.

In the flow of FIG. 12, the camera controller 140 of the present embodiment first determines whether or not the optical/electronic zoom interlocking function is in the ON state (S31). In step S31, the same determination as in step S1 (FIG. 6) of the first embodiment is performed for the setting item “optical/electronic zoom conjunction” instead of the setting item “zoom/MF conjunction”, for example.

The optical/electronic zoom interlocking function in step S31 is a function of interlocking the operation direction D1 of the zoom ring 222 with the operation direction of the focus ring 212 in the electronic zoom operation. For example, such an optical/electronic zoom interlocking function can be set in a setting menu of the digital camera 1, as shown in FIG. 10A.

For example, when the optical/electronic zoom interlocking function is in the ON state (YES in S31), the camera controller 140 detects the operation direction D1 of the zoom ring 222 in the interchangeable lens 200 attached to the camera body 100 (S32), similarly to step S32 of the first embodiment. Next, the camera controller 140 determines whether the operation direction D1 of the zoom ring 222 is the normal rotation or the reverse rotation, similarly to the step S3 of the first embodiment, for example (S33).

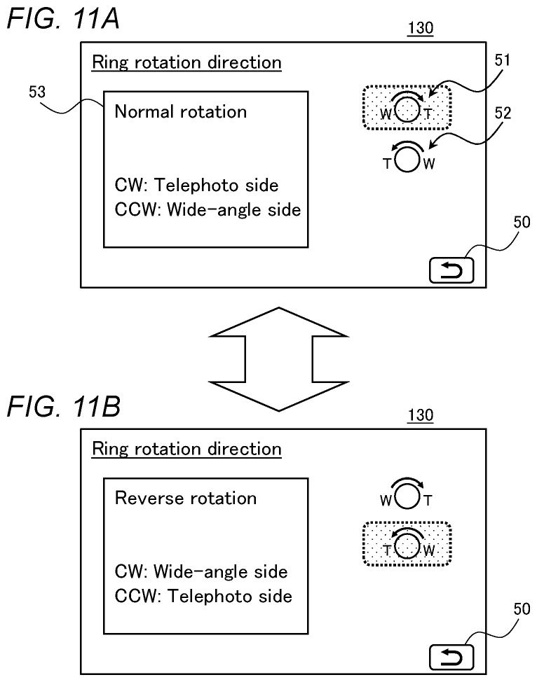

When the operation direction D1 of the zoom ring 222 is the normal rotation (YES in S33), the camera controller 140 sets the operation direction of the focus ring 212 for the electronic zoom operation to the “normal rotation” (S34). According to the setting “normal rotation” of the step S34, the operation parameters such as the electronic zoom magnification are set so that the clockwise rotation operation of the focus ring 212 corresponds to the telephoto side and the counterclockwise operation corresponds to the wide-angle side (see FIG. 11A).

On the other hand, when the operation direction D1 of the zoom ring 222 is the reverse direction (NO in S33), the camera controller 140 sets the operation direction of the focus ring 212 for the electronic zoom operation to the “reverse direction” (S35). According to the setting “reverse rotation” of the step S35, the operation parameters of the electronic zoom are set so that the clockwise rotation operation of the focus ring 212 corresponds to the wide-angle side and the counterclockwise operation corresponds to the telephoto side, contrary to the step S34 (see FIG. 11B).

When the optical/electronic zoom interlocking function is in the OFF state (NO in S31), the camera controller 140 sets the operation direction of the focus ring 212 for the electronic zoom operation in accordance with a user operation on the user interface 150, for example (S30). The process of step S30 is performed by receiving the user operation of selecting “normal rotation” or “reverse rotation” from the setting item “ring rotation direction” on the detailed setting screen of FIG. 10C, for example.

FIG. 11A shows a display example of a selection screen for selecting the normal rotation of the ring rotation direction in the digital camera 1 of the present embodiment. FIG. 11B shows a display example of a selection screen for selecting the reversal of the ring rotation direction. In the example of FIG. 10C, a normal rotation icon 51 is displayed as the current setting state for the setting item “ring rotation direction”.

In this case, when the user selects the setting item “ring rotation direction” by operating the direction button 152 (FIG. 2), the camera controller 140 causes the display monitor 130 to transition to the selection screen illustrated in FIG. 11A, for example. In the digital camera 1, a touch operation by touch panel 155 on display monitor 130 may be input instead of the operation of direction button 152.

The selection screens illustrated in FIGS. 11A and 11B include a normal rotation icon 51 and a reverse rotation icon 52 as options of the setting state of the ring rotation direction, a description field 53 for the state being selected, and a return button 50. The selection screen of FIG. 11A or FIG. 11B can be switched to each other by changing the selection of the normal rotation icon 51 or the reverse rotation icon 52 by the direction button 152 in the user interface 150, for example.

For example, in the selection screen of the ring rotation direction as described above (FIGS. 11A and 11B), the user can operate the return button 50 with a desired setting state selected from “normal rotation” and “reverse rotation”. Then, the camera controller 140 sets the finally selected setting state to the “ring rotation direction”, and returns the display monitor 130 to the detailed setting screen (FIG. 10C) of the electronic zoom function. The camera controller 140 acquires the setting state of the “ring rotation direction” selected by the user operation in this manner as the user setting, and stores the setting state in the flash memory 142 as the setting information, for example (S30).

The camera controller 140 sets the ring rotation direction of the electronic zoom function in any one of steps S34, S34, and S30, and then ends the processing illustrated in the flow of FIG. 12, for example. Thereafter, the camera controller 140 executes, as the zoom processor 145, an electronic zoom operation corresponding to a rotation operation of the focus ring 212 by the user in accordance with the set ring rotation direction, when the digital camera 1 operates in the AF mode, for example.

According to the above processing, the digital camera 1 of the present embodiment can align the operation directions of the rings 212, 222 around the interchangeable lens 200 for various types of zoom, and can make it easy for the user to use the zooming operation of the digital camera 1.

In the above description, an example has been described in which, when the optical/electronic zoom interlocking function is in the OFF state (NO in S31), the operation direction of the focus ring 212 for the electronic zoom operation is set in accordance with the user operation (S30). In the digital camera 1 of the present embodiment, even when the optical/electronic zoom interlocking function is in the ON state, the operation direction of the focus ring 212 may be set according to the user operation. For example, the camera controller 140 may set the operation direction of the focus ring 212 according to the detection result of the operation direction of the zoom ring 222 as the initial value of the ring rotation direction on the function setting screen (FIG. 10B) of the focus ring 212.

### 3. Review

As described above, in the imaging apparatus according to the present exemplary embodiment, the first operation parameter indicates the first zoom magnification such as the optical zoom in the imaging apparatus. The second operation parameter indicates a second zoom magnification such as an electronic zoom in the imaging apparatus. The camera controller 140 changes the second operation direction in accordance with the detected first operation direction so that the orientation in which the second zoom magnification increases in the second operation direction matches the orientation in which the first zoom magnification increases in the first operation direction. The camera controller 140 may change the second operation direction so that the orientation in which the second zoom magnification decreases in the second operation direction matches the orientation in which the first zoom magnification decreases in the first operation direction. Accordingly, the imaging apparatus of the present embodiment can make it easy to operate the operation member of the optical system in various zooming operations.

### Other Embodiments

As described above, the first and second embodiments have been described as examples of the technique disclosed in the present application. However, the technique in the present disclosure is not limited to this, and is applicable to embodiments in which changes, replacements, additions, omissions, and the like are made as appropriate. In addition, it is also possible to combine the respective constituent elements described in the above respective embodiments to form a new embodiment. Therefore, other embodiments will be exemplified below.

Although the digital camera 1 in which the optical zoom mechanism of the interchangeable lens 200 is a mechanical type has been described in the first and second embodiments, the optical zoom mechanism of the interchangeable lens 200 may be an electric type in the digital camera 1 of the present embodiment. For example, the interchangeable lens 200 of the present embodiment includes, as an electric optical zoom mechanism, the zoom lens 220 similar to that of the first embodiment, an electric zoom lens driver instead of the zoom lens drive mechanism 221, and a zoom ring for giving a drive instruction thereof. The interchangeable lens 200 of the present embodiment may include a zoom lever additionally or alternatively to the zoom ring. Even in such a case, the digital camera 1 of the present embodiment can detect the optical zoom operation direction set in advance in the zoom ring or the zoom lever in the electric optical zoom mechanism in the same manner as in the above embodiments, and automatically set the second operation direction.

In present embodiment, the digital camera 1 may automatically set the operation direction of the optical zoom by, for example, an electric zoom ring or a zoom lever in the interchangeable lens 200. For example, in the present embodiment, the camera controller 140 may detect the operation direction of the MF operation or the electronic zoom of the focus ring 212, and set the operation direction of the zoom ring or the like so as to align the operation directions as in the first or second embodiment. This also enables the digital camera 1 of the present embodiment to obtain the same effects as those of the first and second embodiments. In this case, the focus ring 212 is an example of the first operation member, and the zoom ring is an example of the second operation member.

In the above embodiments, the digital camera 1 that performs optical zoom different from electronic zoom has been described. Additionally or alternatively, the digital camera 1 of the present embodiment may perform hybrid zoom in which electronic zoom and optical zoom are performed at the same time, for example. For example, the digital camera 1 of the present embodiment may detect the operation direction of the hybrid zoom by the zoom ring 222, and automatically set the operation direction of various operations as in the above embodiments. Alternatively, the digital camera 1 of the present embodiment may automatically set the operation direction of the hybrid zoom function when the hybrid zoom function is assigned to an operation member such as an electric zoom ring. According to the digital camera 1 of the present embodiment, the user can easily operate the hybrid zoom.

As described above, in the imaging apparatus according to the present embodiment, the first operation parameter may indicate a zoom magnification based on at least one of: optical zoom by an optical system; or electronic zoom by electronic processing of image data in the imaging apparatus. This makes it possible to facilitate various zoom operations using the operation member of the optical system in the imaging apparatus of the present embodiment.

In the above embodiments, the focus ring 212 has been described as an example of the second operation member in the interchangeable lens 200 of the digital camera 1, but the second operation member may be an operation member other than the focus ring 212. For example, the interchangeable lens 200 may include an operation member such as a dedicated control ring for assigning various functions of the digital camera 1. In such a case, the digital camera 1 of the present embodiment may assign the MF function, various zoom functions, or the like to the control ring. Even in this case, the operation of the digital camera 1 can be facilitated by automatically setting the operation direction for the function assigned to the control ring as an example of the second operation member, as in the above embodiments.

Alternatively, in the digital camera 1 of the present embodiment, the control ring of the interchangeable lens 200 may be an example of the first operation member, and the second operation direction in various second operation members may be automatically set according to the operation direction of the function assigned to the control ring. In the digital camera 1 of the present embodiment, the first and second operation members are not limited to the above examples, and may be various operation members in the interchangeable lens 200.

In the second embodiment, assigning of the function in the AF mode has been described. The digital camera 1 of the present embodiment is not particularly limited to the AF mode, and the electronic zoom function may be assigned to the operation member in the MF mode, for example. In the second embodiment described above, the electronic zoom function is assigned to the operation member of the interchangeable lens 200, but the digital camera 1 of the present embodiment is not limited thereto. For example, an operation member dedicated to the electronic zoom function may be provided. The digital camera 1 of the present embodiment does not necessarily have the function of “focus ring setting at AF”.

In the above-described embodiments, the lens interchangeable digital camera has been described as an example of the imaging apparatus, but the imaging apparatus of the present embodiment may be a digital camera that is not particularly a lens interchangeable type. The idea of the present disclosure is applicable not only to a digital camera but also to a movie camera and an electronic apparatus having various imaging functions.

### Aspect Example

Various aspects according to the present disclosure will be listed below.

A first aspect according to the present disclosure is an imaging apparatus including: an image sensor that captures a subject image via an optical system to generate image data; and a controller that controls an operation of the optical system. The optical system is provided with: a first operation member that changes a first operation parameter; and a second operation member that changes a second operation parameter. The controller: detects a first operation direction that associates a user operation on the first operation member with a change in the first operation parameter; and sets a second operation direction in the second operation member to change the second operation direction in accordance with the detected first operation direction, the second operation direction associating a user operation on the second operation member with a change in the second operation parameter.

According to a second aspect, in the imaging apparatus according to the first aspect, the first operation parameter indicates a zoom magnification based on at least one of optical zoom by the optical system or electronic zoom by electronic processing of the image data in the imaging apparatus.

According to a third aspect, in the imaging apparatus according to the second aspect, the second operation parameter indicates a focus position by the optical system. In accordance with the detected first operation direction, the controller changes the second operation direction to match an orientation for which the focus position is moved away in the second operation direction with an orientation for which the zoom magnification increases in the first operation direction.

According to a fourth aspect, in the imaging apparatus according to the first aspect, the first operation parameter indicates a first zoom magnification in the imaging apparatus. The second operation parameter indicates a second zoom magnification in the imaging apparatus. In accordance with the detected first operation direction, the controller changes the second operation direction to match an orientation for which the second zoom magnification increases in the second operation direction with an orientation for which the first zoom magnification increases in the first operation direction.

According to a fifth aspect, in the imaging apparatus according to any one of the first to fourth aspects, the first operation member is an operation ring that is provided in an annularly shape around the optical system and is rotatable about an optical axis of the optical system. The second operation member is an operation ring that is provided in an annular shape around the optical system separately from the first operation member and is rotatable about the optical axis. The controller detects the first operation direction in a direction for which the first operation member rotates, to change the second operation direction in a direction for which the second operation member rotates.

According to a sixth aspect, in the imaging apparatus according to any one of the first to fifth aspects, the optical system and the first and second operation members are included in an interchangeable lens that is detachably attachable to the imaging apparatus, the imaging apparatus further comprises a communication interface that communicates data with the attached interchangeable lens, and the controller detects the first operation direction by data communication with the interchangeable lens via the communication interface.

According to a seventh aspect, in the imaging apparatus according to the sixth aspect, the controller transmits setting information to the interchangeable lens via the communication interface to set up the second operation direction in the second operation member in accordance with the detected first operation direction, the setting information indicating the second operation direction.

An eighth aspect is a control method for controlling an operation by an optical system of an imaging apparatus. The optical system being provided with: a first operation member that changes a first operation parameter; and a second operation member that changes a second operation parameter. The control method includes: detecting, by a controller of the imaging apparatus, a first operation direction that associates a user operation on the first operation member with a change in the first operation parameter; and setting, by the controller, a second operation direction in the second operation member to change the second operation direction in accordance with the detected first operation direction, the second operation direction associating a user operation on the second operation member with a change in the second operation parameter.

A ninth aspect is a program for causing a processor to execute the control method according to the eighth aspect, or a non-transitory computer-readable storage medium storing the program.

A tenth aspect is an interchangeable lens detachably attachable to an imaging apparatus, including: a communication interface that communicates data with the attached imaging apparatus; an optical system that forms an image on an image sensor of the imaging apparatus, based on incident light; a first operation member that changes a first operation parameter; a second operation member that changes a second operation parameter; and a controller that controls an operation of the optical system, based on information received from the imaging apparatus via the communication interface. The controller: causes the imaging apparatus to detect a first operation direction by data communication with the imaging apparatus via the communication interface, the first operation direction associating a user operation on the first operation member with a change in the first operation parameter; receives setting information from the imaging apparatus via the communication interface, the setting information indicating a second operation direction that associates a user operation on the second operation member with a change in the second operation parameter; and in response to a user operation on the second operation member, causes the optical system to change the second operation parameter in accordance with the second operation direction indicated by the setting information.

As described above, the exemplary embodiments have been described as examples of the technique in the present disclosure. For this purpose, the accompanying drawings and the detailed description are provided.

Therefore, the components described in the accompanying drawings and the detailed description may include not only components essential for solving the problem but also components not essential for solving the problem in order to illustrate the above technique. Therefore, it should not be immediately recognized that the non-essential components are essential because the non-essential components are described in the accompanying drawings and the detailed description.

In addition, since the above-described exemplary embodiments are intended to illustrate the technique in the present disclosure, various changes, substitutions, additions, omissions, and the like can be made within the scope of the claims or the scope of equivalents thereof.

### INDUSTRIAL APPLICABILITY

The present disclosure is applicable to an imaging apparatus and an interchangeable lens that use an operation member provided in an optical system.

1. An imaging apparatus comprising:
an image sensor that captures a subject image via an optical system to generate image data; and
a controller that controls an operation of the optical system, wherein
the optical system is provided with: a first operation member that changes a first operation parameter; and a second operation member that changes a second operation parameter,
wherein the controller:
detects a first operation direction that associates a user operation on the first operation member with a change in the first operation parameter; and
sets a second operation direction in the second operation member to change the second operation direction in accordance with the detected first operation direction, the second operation direction associating a user operation on the second operation member with a change in the second operation parameter.

2. The imaging apparatus according to claim 1, wherein the first operation parameter indicates a zoom magnification based on at least one of optical zoom by the optical system or electronic zoom by electronic processing of the image data in the imaging apparatus.

3. The imaging apparatus according to claim 2, wherein
the second operation parameter indicates a focus position by the optical system, and
in accordance with the detected first operation direction, the controller changes the second operation direction to match an orientation for which the focus position is moved away in the second operation direction with an orientation for which the zoom magnification increases in the first operation direction.

4. The imaging apparatus according to claim 1, wherein
the first operation parameter indicates a first zoom magnification in the imaging apparatus,
the second operation parameter indicates a second zoom magnification in the imaging apparatus, and
in accordance with the detected first operation direction, the controller changes the second operation direction to match an orientation for which the second zoom magnification increases in the second operation direction with an orientation for which the first zoom magnification increases in the first operation direction.

5. The imaging apparatus according to claim 1, wherein
the first operation member is an operation ring that is provided in an annularly shape around the optical system and is rotatable about an optical axis of the optical system,
the second operation member is an operation ring that is provided in an annular shape around the optical system separately from the first operation member and is rotatable about the optical axis, and
the controller detects the first operation direction in a direction for which the first operation member rotates, to change the second operation direction in a direction for which the second operation member rotates.

6. The imaging apparatus according to claim 1, wherein
the optical system and the first and second operation members are included in an interchangeable lens that is detachably attachable to the imaging apparatus,
the imaging apparatus further comprises a communication interface that communicates data with the attached interchangeable lens, and
the controller detects the first operation direction by data communication with the interchangeable lens via the communication interface.

7. The imaging apparatus according to claim 6, wherein
the controller transmits setting information to the interchangeable lens via the communication interface to set up the second operation direction in the second operation member in accordance with the detected first operation direction, the setting information indicating the second operation direction.

8. A control method for controlling an operation of an optical system of an imaging apparatus,
the optical system being provided with: a first operation member that changes a first operation parameter; and a second operation member that changes a second operation parameter,
the control method comprising:
detecting, by a controller of the imaging apparatus, a first operation direction that associates a user operation on the first operation member with a change in the first operation parameter; and
setting, by the controller, a second operation direction in the second operation member to change the second operation direction in accordance with the detected first operation direction, the second operation direction associating a user operation on the second operation member with a change in the second operation parameter.

9. A non-transitory computer-readable storage medium storing a program for causing a processor to execute the control method according to claim 8.

10. An interchangeable lens detachably attachable to an imaging apparatus, comprising:
a communication interface that communicates data with the attached imaging apparatus;
an optical system that forms an image on an image sensor of the imaging apparatus, based on incident light;
a first operation member that changes a first operation parameter;
a second operation member that changes a second operation parameter; and
a controller that controls an operation of the optical system, based on information received from the imaging apparatus via the communication interface,
wherein the controller:
causes the imaging apparatus to detect a first operation direction by data communication with the imaging apparatus via the communication interface, the first operation direction associating a user operation on the first operation member with a change in the first operation parameter;
receives setting information from the imaging apparatus via the communication interface, the setting information indicating a second operation direction that associates a user operation on the second operation member with a change in the second operation parameter; and
in response to a user operation on the second operation member, causes the optical system to change the second operation parameter in accordance with the second operation direction indicated by the setting information.
